(19) United States
(12) Patent Application Publication
(10) Pub. No.: US 2026/0145865 A1
(43) Pub. Date: May 28, 2026

(54) Dispenser Tube with Scraping Device

(71) Applicants: Yashmatie Hossain, East Gwillimbury (CA); Timothy Hossain, East Gwillimbury (CA)

(72) Inventors: Yashmatie Hossain, East Gwillimbury (CA); Timothy Hossain, East Gwillimbury (CA)

(21) Appl. No.: 18/961,740

(22) Filed: Nov. 27, 2024

(51) Int. Cl. B65D 83/32; A47K 5/12; B65D 83/34

(52) U.S. Cl. CPC B65D 83/32; B65D 83/34; A47K 5/1205

(57) ABSTRACT

A dispenser tube with scraping device is provided. The dispenser tube with scraping device includes a curved tubing attachable to a pump, which includes a blade designed to retrieve remaining product from the interior surfaces of a bottle when the pump can no longer effectively dispense product. The dispenser tube with scraping device doubles as a spatula, allowing the user to reach product at the bottom and along the sides of the bottle, maximizing product usage. The blade includes a flexible, flat surface extending along a majority of a length of the tubing and capable of conforming to the inner curvature of the bottle, moving residual contents downward for easier access when rotated. This design ensures minimal product waste and improved consumer convenience by allowing nearly complete dispensing of bottle contents.

### BACKGROUND OF THE INVENTION

The present invention relates to dispensers designed to maximize product retrieval in bottles and tubes, specifically those with pump or squeeze mechanisms that commonly leave residual product inaccessible to the user.

Bottles and tubes with pump dispensers are widely used for a variety of liquid or semi-solid products, including lotions, shampoos, and other personal care or cosmetic items. These products are often housed in containers that rely on a pump mechanism to extract the product. However, when the bottle nears emptiness, a significant amount of product often remains at the bottom and sides of the container, beyond the reach of the standard pump. This inefficiency results in product waste and user frustration, as consumers must either attempt to extract the remaining product by shaking, cutting open the bottle, or discarding the container with product still inside.

Some existing solutions attempt to address this issue with modifications to the pump structure or with specialized spatula tools, but these approaches are limited in effectiveness. For instance, some pumps include an extended straw to reach the bottom of the bottle, but this design does not address the issue of product clinging to the sides of the container. In other cases, separate spatula tools are marketed as a solution for retrieving residual product, but these tools are inconvenient for users as they require additional handling and may not effectively reach all interior surfaces of the bottle. In the case of tubes, some designs have attempted to incorporate squeezable materials or collapsible components to force out more product, but these solutions fail to provide a means to scrape the sides and are generally limited in their ability to ensure full use of the product.

Therefore, there is a need for a device that allows users to retrieve nearly all remaining product from the interior of a bottle or tube without requiring separate tools or excessive effort. The present invention provides a dispenser with a scraping device that is integrated into the pump assembly or tube structure itself. This device comprises a curved tubing and blade that serves as an internal scraping tool. These features overcome the limitations of existing products by allowing users to efficiently access and use all remaining product, thereby reducing waste and enhancing user satisfaction.

In light of the devices disclosed in the known art, it is submitted that the present invention substantially diverges in design elements and methods from the known art and consequently it is clear that there is a need in the art for an improvement for a dispenser tube with scraping device. In this regard the instant invention substantially fulfills these needs.

### SUMMARY OF THE INVENTION

In view of the foregoing disadvantages inherent in the known types of dispenser tubes now present in the known art, the present invention provides a new dispenser tube with scraping device configured retrieve remaining product from the interior surfaces of a bottle when the pump can no longer effectively dispense product.

It is an objective of the present invention to provide a dispenser tube with scraping device that includes a curved tubing and an attached blade designed to retrieve residual product from the interior surfaces of a bottle when traditional pump mechanisms fail to do so. The blade is configured to engage an interior side of the bottle when the curved tubing is selectively rotated about the opening of the bottle. The curved tubing doubles as a spatula, allowing users to access and apply product remaining on the bottom and sides of the container, thus maximizing product utilization and minimizing waste.

It is an objective of the present invention to provide a dispenser tube with scraping device configured to attach to standard pump mechanisms for easy integration into existing product bottles.

It is an objective of the present invention to provide a dispenser tube with scraping device that is constructed from materials compatible with a variety of liquid and semi-solid products, including cosmetics and personal care items. The device's components are composed of flexible, food-grade materials that are durable, easy to clean, and suitable for use with formulations commonly found in skincare, haircare, and other consumable products.

It is therefore an object of the present invention to provide a new and improved new a dispenser tube with scraping device that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings.

FIG. 1 shows a perspective view of an embodiment of the dispensing tube with scraping device attached to a dispenser.

FIG. 2 shows a side view of an embodiment of the dispensing tube with scraping device attached to a dispenser.

FIG. 3 shows a side view of an alternate embodiment of the dispensing tube with scraping device.

FIG. 4 shows a perspective view of an embodiment of the dispensing tube with scraping device attached in use.

### DETAILED DESCRIPTION OF THE INVENTION

Reference is made herein to the attached drawings. For the purpose of presenting a brief and clear description of the present invention, the preferred embodiment will be discussed as used for retrieving remaining product from the interior surfaces of a bottle when the pump can no longer effectively dispense product. The figures are intended for representative purposes only and should not be considered to be limiting in any respect.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

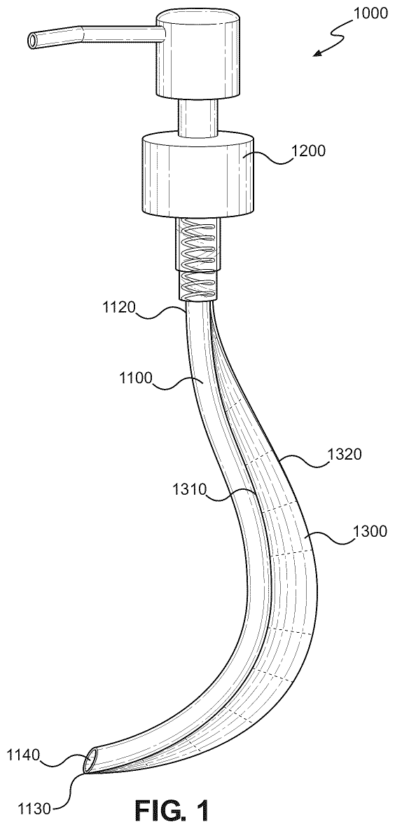

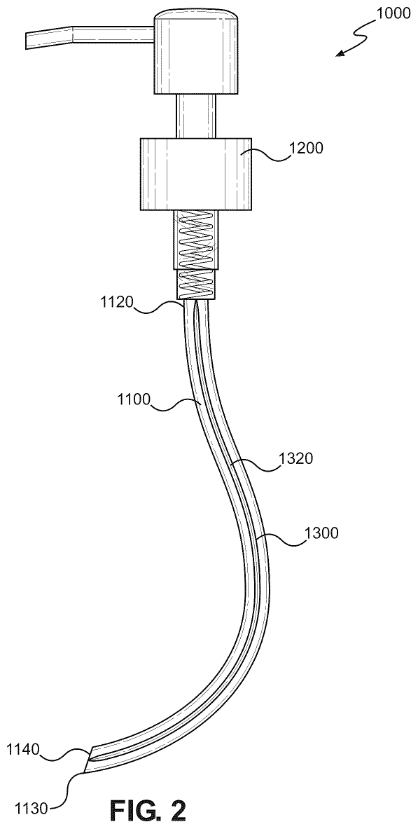

Referring now to FIGS. 1 and 2, there is shown a perspective view of an embodiment of the dispensing tube with scraping device attached to a dispenser and a side view of an embodiment of the dispensing tube with scraping device attached to a dispenser, respectively. The dispenser tube with scraping device 1000 comprises a tubing 1100 configured to attach to a pump dispenser 1200 on a bottle. The tubing 1100 comprises a first end 1120 and an opposing second end 1130, wherein the first end 1120 is configured to secure to the pump dispenser 1200. In the illustrated embodiment, the tubing 1100 is configured to insert within the pump dispenser via a friction fit. In alternate embodiments, the tubing comprises a fastener, such as threading or a lip that secures to a mating fastener of the pump dispenser. The first and second ends 1120, 1130 of the tubing 1100 are open to allow fluid to freely pass therethrough. In the illustrated embodiment. The opening 1140 at the second end 1120 of the tubing is slanted. In this way, the tubing 1100 can more easily reach a corner of the bottle to access remaining fluid therein.

In the illustrated embodiment, the second end 1120 of the tubing 1100 is curved such that the opening 1140 is configured to face the sidewall of the bottle when the tubing is secured to the pump dispenser and placed within the bottle. This configuration allows the tubing to access more viscous fluid, such as lotion, stuck on the interior surfaces of the bottle, adjacent to the sidewalls thereof. In the illustrated embodiment, the tubing 1100 is transparent to allow a user to observe fluid disposed within the tubing. In the illustrated embodiment, the tubing 1100 comprises a circular shaped cross section. However, other embodiments comprise tubing having any suitable shaped cross section.

The dispenser tube with scraping device 1000 further includes a blade 1300 secured to the exterior sidewall of the tubing 1100. The blade 1300 includes a flexible, flat surface adapted to conform to the inner curvature of the bottle. The blade 1300 comprises a first lateral side 1310 and an opposing second lateral side 1320, wherein the first lateral side 1310 is secured directly to the tubing 1100 and the second lateral side 1320 is configured to contact the sidewall of the bottle.

The blade 1300 comprises a greater width at the second end of the tubing 1100, wherein the width is measured between the pair of lateral sides 1310, 1320. In the illustrated embodiment, the width of the blade 1300 tapers to a smaller width towards the first end and the second end of the tubing 1100. The blade 1100 extends from the first end to the second end of the tubing 1100, such that the blade is disposed along a majority of the length of the tubing 1100. In some embodiments, the blade is disposed along the entire length of the tubing. The scooping component 1300 is configured to scrape the interior sidewalls of the bottle, pushing product stuck on the sidewalls downwards towards the opening 1140 of the tubing 1100. In the illustrated embodiment, the tubing 1100 and blade 1300 are formed of a food-grade, flexible material.

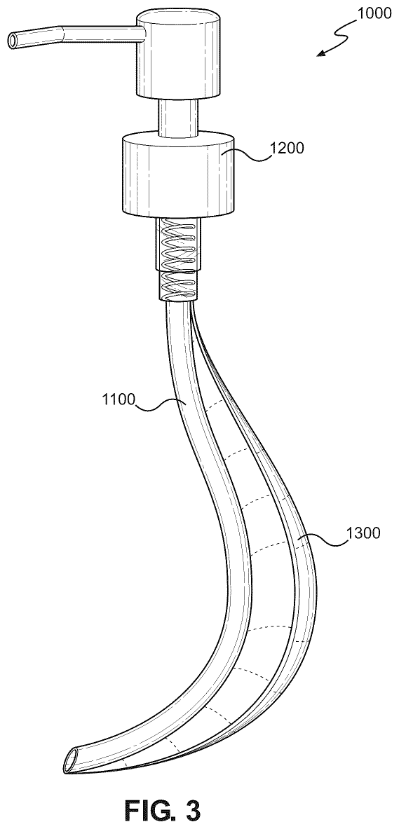

Referring now to FIG. 3, there is shown a side view of an alternate embodiment of the dispensing tube with scraping device. In the illustrated embodiment, the blade 1300 comprises a concave surface such that when the tubing 1100 is rotated in a first direction about a vertical axis, excess fluid can be scooped within the concave portion and removed through the opening of the bottle, not via the tubing. The scooping component 1300 is configured to serve as a spatula, enabling a user to scoop product from the interior surfaces of the bottle when the pump dispenser fails to dispense remaining product.

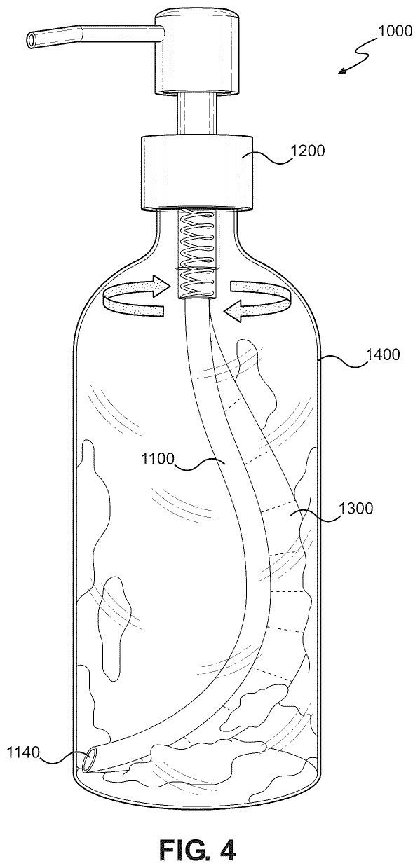

Referring now to FIG. 4, there is shown a perspective view of an embodiment of the dispensing tube with scraping device attached in use. In operation, the tubing 1100 and blade 1300 are secured to a pump dispenser 1200 and inserted into a bottle 1400 with a viscous fluid or product, such as lotion. Once the product can no longer be effectively pumped through the tubing 1100 via the pump dispenser 1200, the tubing 1100 is rotated about a vertical axis such that the blade contacts the interior sidewalls of the bottle to retrieve residual product from interior surfaces. The tubing can be still fastened to the pump dispenser or separated therefrom. The product can either be pushed downwards towards the opening 1140 of the tubing 1100 or collected on the surface of the blade 1300 and removed from the opening of the bottle. In some embodiments, the dispensing tubing with scraping device 1000 includes the pump dispenser 1200, whereas in alternate embodiments, the pump dispenser is not included. Furthermore, in some embodiments, the tubing is fastened to the pump dispenser such that the pump dispenser can be rotated while secured to the bottle, causing the tubing and blade to rotate within the bottle.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A dispenser tube with scraping device, comprising:
a curved tubing configured to attach to a pump dispenser on a bottle, the tubing including an attached blade;
wherein the blade extends from a first end to a second end of the tubing;
wherein the blade is configured to contact an interior sidewall of the bottle to collect residual product from interior surfaces of the bottle;
wherein the blade is configured to engage an interior side of the bottle when the curved tubing is selectively rotated about the opening of the bottle;
wherein the curved tubing is asymmetrical and includes a hook shape that is offset from a central axis of the bottle, the central axis extending from the pump dispenser outlet through a center axis of the bottle.

2. The dispenser tube with scraping device of claim 1, wherein the blade extends along a majority of a length of the tubing.

3. The dispenser tube with scraping device of claim 1, wherein the blade is flexible and includes surface adapted to conform to the inner curvature of the bottle.

4. The dispenser tube with scraping device of claim 3, wherein the blade comprises a first lateral side and an opposing lateral side, wherein the first lateral side is secured to the tubing and the second lateral side is configured to contact the sidewall of the bottle.

5. The dispenser tube with scraping device of claim 4, wherein the blade comprises a greater width at the second end of the tubing, wherein the width is measured between the pair of lateral sides.

6. The dispenser tube with scraping device of claim 5, wherein the width of the blade tapers towards the first end of the tubing.

7. The dispenser tube with scraping device of claim 1, wherein the tubing is curved at the second end thereof wherein an opening of the tubing is configured to face a sidewall of the bottle when the tubing is secured to the pump dispenser and the bottle.

8. The dispenser tube with scraping device of claim 1, wherein the first end of the tubing is securable to the pump dispenser via a friction fit.

9. The dispenser tube with scraping device of claim 1, further comprising the pump dispenser and the bottle.

10. The dispenser tube with scraping device of claim 1, wherein the tubing is transparent.

11. The dispenser tube with scraping device of claim 1, wherein the blade comprises a concave surface between a first and second lateral side thereof.

12. The dispenser tube with scraping device of claim 1, wherein the tubing and blade are formed of a food-grade, flexible material.

13. The dispenser tube with scraping device of claim 1, wherein the blade is integral with the tubing.

14. The dispenser tube with scraping device of claim 1, the blade extends the entire length of the tubing.

15. The dispenser tube with scraping device of claim 1, wherein the blade is spiral.

16. The dispenser tube with scraping device of claim 1, wherein the blade extends radially from a longitudinal axis of the tubing, wherein the longitudinal axis runs between the first and second ends of the tubing.

17. The dispenser tube with scraping device of claim 1, wherein the second end of the tubing is slanted.
